(19) United States
(12) Patent Application Publication
(10) Pub. No.: US 2017/0305245 A1
(43) Pub. Date: Oct. 26, 2017

(54) POLYMERIC PANE WITH EXTRUDED-ON SEALING PROFILE

(71) Applicant: SAINT-GOBAIN GLASS FRANCE, Courbevoie (FR)

(72) Inventors: Thomas LUX, WEISSACH IM TAL (DE); Sebastian SCHMIDT, STUTTGART (DE); Uwe WEISSENBERGER, WUERZBURG (DE); Stefan BUMANN, MONSCHAU (DE)

(21) Appl. No.: 15/531,733

(22) PCT Filed: Nov. 26, 2015
(86) PCT No.: PCT/EP2015/077740

§ 371 Date: May 30, 2017

(30) Foreign Application Priority Data
Dec. 18, 2014 (EP) 14198806.3

(51) Int. Cl. B60J 10/34; B29C 37/00; B29C 47/02; B60J 1/20; B60J 10/70; B60J 1/00; B29C 35/00; B29C 47/06; B29L 31/30; B29L 31/26

(52) U.S. Cl. CPC B60J 10/34; B29C 35/002; B29C 37/0025; B29C 47/02; B29C 47/067; B60J 1/2094; B60J 10/70; B60J 1/003; B29K 2995/0025; B29K 2995/007; B29L 2031/265; B29L 2031/3052; B29K 2995/0026

(57) ABSTRACT

A polymeric pane, having a polymeric main body with a first pane surface, a second pane surface, a peripheral pane edge, and a protective coating on the entire second pane surface and on at least part of the first pane surface. An extruded-on sealing profile is mounted on the side of the first pane surface via an adhesion promoter.

The invention relates to a polymeric pane, a method for producing such a pane, and use thereof.

Various methods are known for providing panes with a profile strand made of plastic, for example, a thermoplastic elastomer. In the case of vehicle window panes, these surrounds made of plastic are used for sealing and/or attaching motor vehicle window panes in the window openings.

In the wake of increasingly stringent requirements regarding carbon dioxide emissions of motor vehicles, there are strong efforts to reduce the weight of a motor vehicle and thus its fuel consumption. As part of constant innovations in the plastics sector, elements made of polymeric materials can be used in the entire window region. Due to the weight reduction, the center of gravity of the motor vehicle moves downward, which has a positive effect on handling.

In order for panes made of polymeric materials to have scratch resistance properties comparable to panes made of glass, they are provided with a protective coating, a so-called hardcoat. This protective layer alters the surface properties of the pane such that standard processes which are used for the bonding of seals to be mounted with panes made of glass are often unsuitable for coated polymeric panes.

The surrounding of polymeric panes with profile strands made of plastic, such as, for example, with a thermoplastic elastomer, is typically done using the injection molding process. Here, first, an adhesion promoter or primer is applied to the position of the polymeric pane on which the profile strand is to be situated later, the primer is activated, for example, by heating, the polymeric pane is placed in a molding tool, a thermoplastic elastomer is injected onto the primer/adhesion promoter, and the pane is removed from the molding tool.

EP 2 144 958 B1 describes a corresponding method for producing plastic glazings with a profile strand. First, a plastic sheet is provided, which is then placed in a mold into which the material of the profile strand is then injected. Then, the plastic sheet with the profile strand is removed from the mold. A disadvantage of this method is the necessity of having to produce a separate costly mold for each new geometric shape of a pane. In particular, with small lots, the production costs per piece are significantly elevated.

Depending on the type of protective coating applied on the polymeric panes, the use of such a method becomes difficult since, due to the altered surface, the primers customarily used do not adequately wet it, and, hence, suitable adhesion conditions between the surface and the primer cannot be achieved. This problem arises, for example, with the use of polysiloxane-containing protective coatings. Consequently, the protective coating must be removed in advance in the regions to be coated. This is done by milling or grinding the protective coating, which is very time-consuming and thus results in decreased productivity. Moreover, during the grinding, additional waste and noise is created by the grinding process, which is disadvantageous in terms of environmental protection and occupational safety. Special adhesion-modified thermoplastic elastomer systems are often used to obtain adequate wetting so that the injected thermoplastic elastomers for the profile strand adhere well to the abraded surface of the polymeric pane. These systems can be very costly.

An object of the present invention is to produce an improved polymeric pane provided with a sealing profile, which pane can be produced simply and economically. Another object of the present invention is to make available an improved method for producing a polymeric pane according to the invention.

The object of the present invention is accomplished by a polymeric pane according to the invention in accordance with claim 1. The polymeric pane according to the invention comprises at least a polymeric main body with a first pane surface, a second pane surface, a peripheral pane edge, and a protective coating on the entire second pane surface and on at least part of the first pane surface, wherein, at least on the side of the first pane surface, an extruded-on sealing profile is mounted via an adhesion promoter.

The second pane surface is provided with protective coating on its entire surface and is thus completely protected against mechanical damage such as scratching. It is thus particularly suited, after installation in an opening provided therefor, to face the side that is exposed to the greatest mechanical stresses. In the case of use of the polymeric pane as a motor vehicle window pane, the second pane surface accordingly faces toward the outside, while the first pane surface faces the motor vehicle interior. The adhesion promoter is applied on the first pane surface and the sealing profile is extruded onto the first pane surface. In the context of the invention “extruded-on” means that the sealing profile is applied in situ on the adhesion promoter, in contrast to a finished extruded component that is subsequently glued onto the pane. Particularly solid and durably stable bonding to the polymeric pane is produced by direct extrusion onto the polymeric pane. In addition, the necessity for removal of the protective layer and the use of special adhesion-modified, thermoplastic elastomers for the extrusion of the sealing profile is eliminated since, thanks to the direct extrusion onto the polymeric pane, a stable bond is also produced. This was surprising and unexpected for the person skilled in the art.

The polymeric pane in the context of the invention is a flat or curved workpiece made of plastic, which is transparent at least in regions. The polymeric main body can be colorless, colored, or tinted. The polymeric main body can be clear or cloudy. The largest surfaces of the polymeric main body in terms of expansion are referred to as the first and second pane surface. These are the surfaces of the polymeric pane through which an observer would look. After installation in an opening, the pane separates an inside and an outside space from one another, for example, a vehicle interior and a vehicle exterior. According to the invention, the first pane surface then faces toward the interior and the second pane surface faces toward the exterior. The pane edge delimits the polymeric pane toward the outside. The polymeric pane can assume various geometric shapes, for example, be implemented rectangular, square, semicircular, circular, or oval.

“Transparent” means that an observer who looks through this region can recognize objects that are arranged behind the polymeric pane relative to the observer. The transparent region can be colorless. The transparent region can also be colored or tinted. The transmittance level of the transparent region in the visible spectral range (300 nm-800 nm) is at least 5%.

The sealing profile serves for fixing the polymeric pane in an opening, for example, in a window opening, wherein the pane can be installed such that the opening is, for example, sealed against the penetration of moisture. The fixing of a polymeric pane in a window opening using a sealing profile is common. The preparation of a polymeric pane with an at least partially circumferential sealing profile facilitates the subsequent installation in the opening provided therefor.

The sealing profile is mounted via an adhesion promoter (primer). For this, the industry provides a broad assortment of one- and two-component primer systems. Since the sealing profile is extruded on in situ, adhesion promoters that are also used for glass panes can surprisingly be used. The adhesion promoter can contain aqueous or organic solvents. The adhesion promoter can be colorless, clear, opaque, or florescent. Preferably, the adhesion promoter contains polyurethanes, epoxy resins, and or chlorinated polyolefins, for example, chlorinated polypropylenes.

The sealing profile is preferably mounted parallel to the pane edge and the distance a from the sealing profile to the pane edge is less than 5 cm, preferably less than 2 cm, particularly preferably less than 0.5 cm. In this arrangement, good sealing is achieved with low material consumption. The distance a from the sealing profile to the pane edge means the distance between the pane edge and the region of the sealing profile that makes contact with the adhesion promoter.

In a preferred embodiment, the adhesion promoter and the extruded sealing profile are mounted peripherally along the entire pane edge. In this case, the entire perimeter of the pane is provided with an extruded sealing profile, by which means the pane is installed completely sealed.

In an alternative embodiment, the adhesion promoter and the extruded sealing profile are mounted only along part of the pane edge. Thus, material can be saved.

In a preferred embodiment, the extruded sealing profile is mounted that such that it protrudes beyond the pane edge. When the polymeric pane is inserted into the opening provided, the part of the sealing profile protruding beyond the pane edge can lie partially around the pane edge and thus provides for a perfect seal.

In another preferred embodiment, the extruded sealing profile is arranged encompassing the pane edge on the first pane surface and on the second pane surface. The sealing profile surrounds the pane edge and protects the pane edge against damage, during and after installation.

In a preferred embodiment, a black print is provided on the first pane surface at least in one edge region of the pane. The black print is preferably arranged on the polymeric main body under the protective coating. The black print serves to conceal devices that are mounted on the first pane surface and, thus, to improve the visual appearance of the pane. For an observer who looks at the second pane surface, these devices are hidden by the black print. With motor vehicle windowpanes, a black print can, for example, be provided in the region of objects mounted on the pane, for example, sensors or cameras. Wires or cables can also be hidden in this manner. At the points where the sealing profile is arranged in the edge region, the material sequence viewed from the first pane all the way to the polymeric main body is: sealing profile—adhesion promoter—protective coating—black print—polymeric main body. The edge region of the pane is adjacent the pane edge. There, the black print conceals the view of the fixing of the pane by adhesives and sealing means and/or the sealing profile, which can likewise be arranged in the edge region. The black print is preferably arranged in an edge region with a width of 1 cm to 25 cm, preferably 5 cm to 10 cm. The black print can be applied by the screen printing method or the offset method or by spray methods.

In another preferred embodiment, an opaque material phase is provided on the first pane surface at least in the edge region of the pane. This opaque material phase is preferably applied by a two-component injection molding method. The opaque material phase can assume a function similar to that of the black print. By means of the opaque implementation, objects or regions positioned behind the opaque material phase are concealed. The opaque material phase can extend over 2% to 70% of the first pane surface. In the context of the invention, “opaque” means that an observer cannot see through the opaque material phase. The transmittance of the opaque material phase in the visible spectral range is thus significantly reduced and is less than 5%, in particular roughly 0%.

The opaque material phase preferably contains at least polyethylene (PE), polycarbonates (PC), polypropylene (PP), polystyrene, polybutadiene, polynitrils, polyesters, polyurethanes, polymethylmethacrylates, polyacrylates, polyesters, polyamides, polyethylene terephthalate. acrylonitrile butadiene styrene (ABS), styrene acrylonitrile (SAN), acrylonitrile-styrene-acrylester (ASA), acrylonitrile butadiene styrene—polycarbonate (ABS/PC) and/or copolymers or mixtures thereof, particularly preferably polycarbonates (PC), polyethylene terephthalate (PET), and/or polymethylmethacrylate (PMMA).

The opaque material phase preferably contains at least one colorant. The opacity of the component is obtained by means of the colorant. The colorant can contain inorganic and/or organic dyes and/or pigments. The colorant can be colored or achromatic. Suitable colorants are known to the person skilled in the art and can be looked up, for example, in the Colour Index of the British Society of Dyers and Colourists and the American Association of Textile Chemists and Colorists. A black pigment is preferably used as a colorant, for example, carbon black, aniline black, bone black, iron oxide black, spinel black, and/or graphite. Thus, a black opaque component is obtained.

The opaque material phase can contain other inorganic or organic fillers, particularly preferably SiO₂, Al₂O₃, TiO₂, clay materials, silicates, zeolites, glass fibers, plastic fibers, glass beads, organic fibers, and/or mixtures thereof. The fillers can further increase the stability of the opaque component. In addition, the fillers can reduce the content of polymeric materials and thus reduce the production costs of the component.

Preferably, the extruded sealing profile contains thermoplastic elastomers, thermoplastic polyurethanes, styrene copolymers, polyolefin rubber blends, polyolefin elastomer blends, thermoplastic copolyamides, thermoplastic copolyesters, and/or mixtures thereof. With these materials, particularly good sealing can be obtained along with simultaneously good extrusion properties.

The polymeric main body preferably has a thickness of 2 mm to 6 mm. This is particularly advantageous in terms of the strength and processing of the polymeric main body. The size of the polymeric main body can vary widely and is governed by the use according to the invention.

The polymeric main body preferably contains at least polyethylene (PE), polycarbonates (PC), polypropylene (PP), polystyrene, polybutadiene, polynitrils, polyesters, polyurethanes, polymethylmethacrylates, polyacrylates, polyesters, polyamides, polyethylene terephthalate, acrylonitrile butadiene styrene (ABS), styrene acrylonitrile (SAN), acrylonitrile styrene acrylester (ASA), acrylonitrile butadiene styrene—polycarbonate (ABS/PC), and/or copolymers or mixtures thereof.

The polymeric main body particularly preferably contains polycarbonates (PC) and/or polymethylmethacrylate (PMMA). This is particularly advantageous in terms of the transparency in the transparent region, processing, strength, weather resistance, and chemical resistance of the polymeric main body.

The protective coating protects the polymeric pane against mechanical and chemical damage as well as UV radiation. Preferably used are thermally curing or UV curing coating systems based on polysiloxanes, polyacrylates, polymethylacrylates, and/or polyurethanes. The protective coating preferably has a layer thickness of 1 μm to 50 μm, particularly preferably of 2 μm to 25 μm. This is particularly advantageous in terms of the protective action of the coating.

In addition to coloring compounds and pigments, the coating can also contain UV blockers, preservatives, as well as components for increasing scratch resistance, for example, nanoparticles.

The protective coating is cured after application, preferably by introducing temperature andior UV light. Suitable products for use as the protective coating are, for example, AS4000, AS4700, variants of PHC587 or UVHC3000, which are provided by the company Momentive Performance Materials.

An adhesion promoting layer is preferably applied on the polymeric main body before the protective coating. The adhesion promoting layer can, for example, contain acrylates and have a layer thickness of 0.4 μm to 5 μm. The protective coating can, for example, contain polysiloxanes and have a layer thickness of 1 μm to 15 μm.

The object of the present invention is further accomplished according to the invention by a method for producing a polymeric pane, wherein at least:
a polymeric main body is provided,
a protective coating is applied at least on the second pane surface,
an adhesion promoter is applied on the first pane surface in the region provided for the sealing profile, and
a sealing profile is extruded onto the adhesion promoter.

The polymeric main body can be produced by all suitable methods of plastic processing known to the person skilled in the art, for example, by thermal reshaping of a polymeric sheet material in special thermoforming tools. Alternatively, the polymeric main body can be prepared in a single- or multi-component injection molding process, preferably in combination with turning plate technology. Here, an upper and a lower molding tool can be guided positively against one another. A cavity is formed by the two molding tools. Molten polymeric material is injected into the cavity. After curing of the polymeric material, the polymeric workpiece can be removed from the molding tools. In a preferred embodiment, an additional, usually dark-colored opaque material can be molded onto the workpiece in an additional step before the removal of the polymeric workpiece. The shape of the polymeric workpiece corresponds to the shape of the cavity formed by the injection molding tools.

The protective coating can be applied by painting and rolling, spraying of aerosols, powder coating, dip coating, and flow coating of solutions, emulsions, or suspensions, as well as CVD (chemical vapor deposition) and PVD (physical vapor deposition) methods from the gas phase. The protective coating is preferably applied by flow coating. In this method, the workpiece is impinged on from the upper edge with a coating solution, for example, by means of one or a plurality of fixedly mounted flow-coat nozzles, a paint curtain, or a movable flow robot arm. The coating solution running down wets the workpiece. Methods for flow coating are known, for example, from GB 1,097,461 A, GB 1,201,292 A, and GB 2,123,841 A.

Those regions of the polymeric main body onto which the extruded sealing profile is to be applied, are provided, before the extrusion of the sealing profile, with an adhesion promoter (primer), Some of these adhesion promoters must be brought to a temperature of approx. 50° C. to 120° C. immediately before the extrusion of the sealing profile thereon and are thus heat activated. The extrusion thereon is then done in the still warm state of the adhesion promoter. Preferably, adhesion promoters that require no heat activation are used.

In order to achieve optimum adhesion of the sealing profile on the polymeric main body, it can be necessary to activate those regions of the polymeric main body onto which the sealing profile is to be applied before the application of the adhesion promoter. In this manner, the first pane surface is optimally prepared for the subsequent application of the adhesion promoter. For this, all suitable methods for surface activation known to the person skilled in the art can be used, for example, atmospheric plasma, flame treatment, corona treatment, or by application of a liquid activator. Activation by atmospheric plasma is preferred. In particular, when the first pane surface is provided with a protective coating, the adhesion of the sealing profile can be significantly improved with additional activation.

The extrusion of the sealing profile on the adhesion promoter is preferably done using a robot that moves along the pane edge of the stationary polymeric main body and deposits the sealing profile out of a nozzle onto the second pane surface. The forward speed of the nozzle is between 50 mm/s and 300 mm/s, preferably between 100 mm/s and 200 mm/s. Alternatively, the polymeric main body can be moved along a stationary nozzle. Independently of the geometric shape of the polymeric pane, the same method can be used such that even small lots can be produced economically.

The polymeric pane is preferably used as a pane. as a component of a pane, or as a plastic cover of means of transportation for travel on land, in the air, or on water, in particular as a rear window, windshield, side window, roof panel, luminaire covering, molding, and/or as a vehicle roof of passenger cars, trucks, buses, streetcars, subways, trains, and motorcycles. The polymeric pane can also be used in functional and/or decorative individual pieces or as a built-in component in furniture and appliances.

The invention is explained in detail with reference to drawings. The drawings are schematic representations and not true to scale. The drawings in no way restrict the invention, They depict:

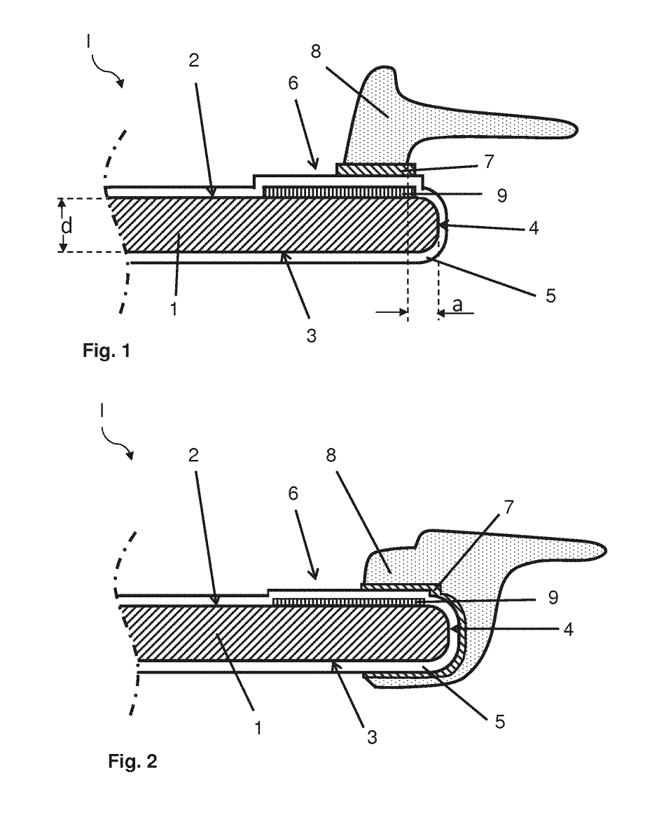

FIG. 1 a cross-section through an embodiment of a polymeric pane according to the invention in the region of the pane edge,

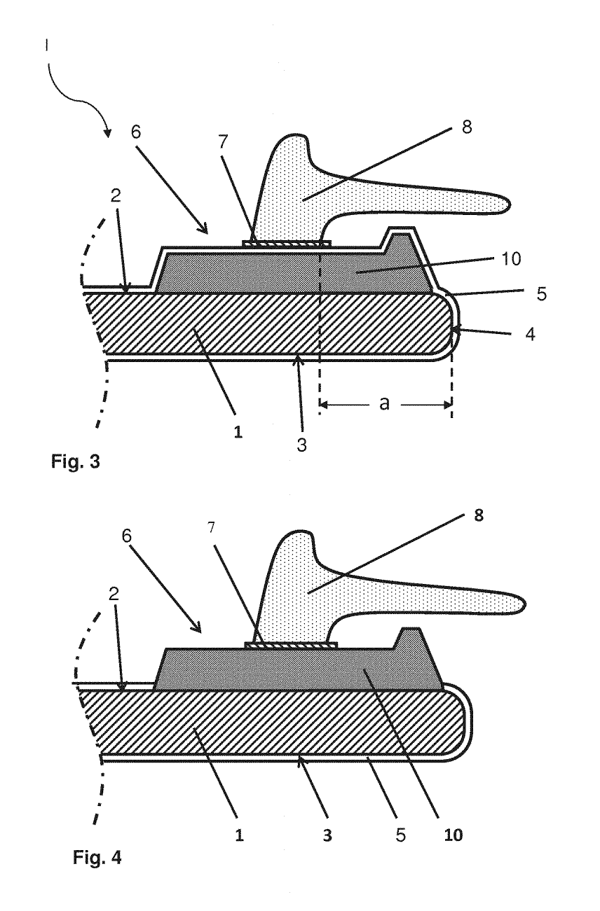

FIG. 2 a cross-section through another embodiment of a polymeric pane according to the invention in the region of the pane edge,

FIG. 3 a cross-section through another embodiment of a polymeric pane according to the invention in the region of the pane edge,

FIG. 4 a cross-section through another embodiment of a polymeric pane according to the invention in the region of the pane edge,

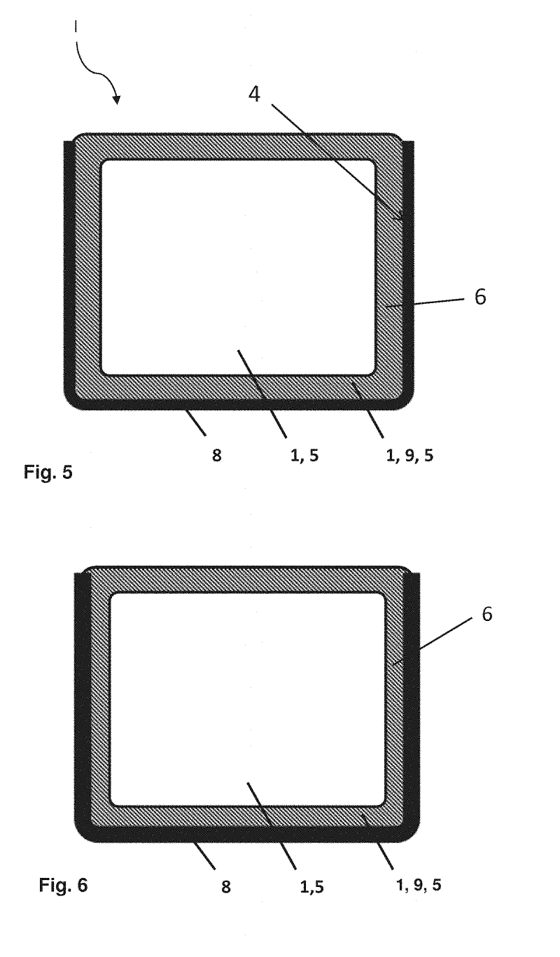

FIG. 5 a top view of the first pane surface of a polymeric pane according to the invention,

FIG. 6 a top view of the second pane surface of a polymeric pane according to the invention,

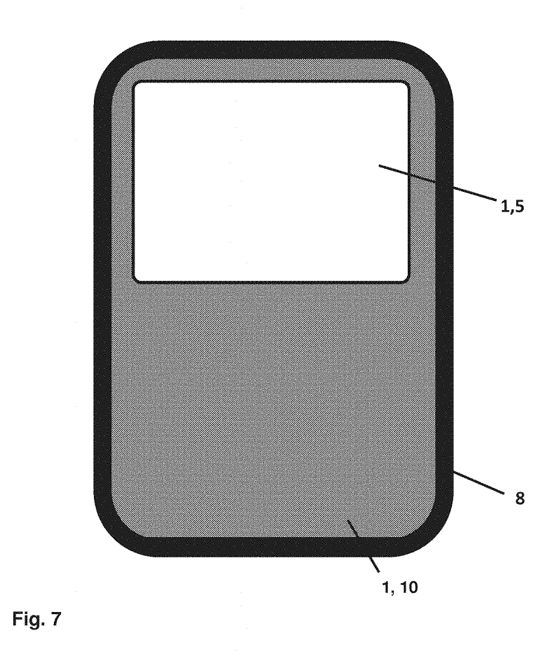

FIG. 7 a top view of the first pane surface of another embodiment of a polymeric pane according to the invention,

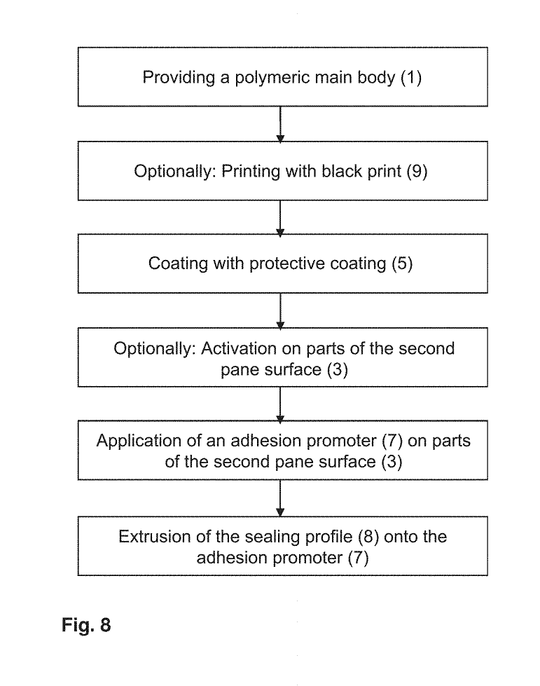

FIG. 8 a flowchart of the method according to the invention for producing a polymeric pane.

FIG. 1 depicts a cross-section through a polymeric pane I produced by thermoforming in the region of the pane edge 4. The polymeric pane I is a rear window of a motor vehicle, The polymeric main body 1 of the polymeric pane I contains polycarbonate (PC) and is implemented transparent. The polymeric main body 1 has a first pane surface 2, a second pane surface 3, and a pane edge 4. The first pane surface 2 and the second pane surface 3 are implemented parallel to one another. The thickness d of the polymeric main body 1 is 4 mm. The second pane surface 3 is intended as an external surface of the rear window. Consequently, it is exposed to particular mechanical and chemical stresses as well as UV radiation. The second pane surface 3 is, consequently, provided with a protective coating 5. The first pane surface 2 is also provided with a protective coating 5, since even the side of the pane facing the motor vehicle interior is exposed to chemical and mechanical stresses, such as, for instance, cleaning agents as well as scratching by vehicle occupants or pieces of luggage that come into contact with the pane. The protective coating 5 contains polysiloxanes. In the edge region 6 of the polymeric main body 1, a black print 9 is applied by a screen printing method on the first pane surface 2. The edge region 6 is roughly 5 cm wide and runs parallel to the pane edge 4. The black print 9 is arranged directly on the polymeric main body 1 and is protected by the protective coating 5. The black print 9 hides an extruded sealing profile 8 and an adhesion promoter 7 when looking at the second pane surface 3 and thus improves the visual impression of the polymeric pane I. The distance a between an extruded sealing profile 8 and the pane edge 4 is roughly 5 mm. Only the part of the extruded sealing profile 8 that is in contact with the adhesion promoter 7 is considered for the determination of the distance a. The distance a is then determined from the beginning of the extruded sealing profile 8, viewed from the pane edge 4. The extruded sealing profile 8 runs parallel to the pane edge 4 and protrudes beyond the pane edge 4. If the polymeric pane I is installed in a window opening, the part of the sealing profile 8 protruding beyond the pane edge 4 can be positioned around the pane edge 4 and thus provide for good sealing. The extruded sealing profile 8 contains a thermoplastic elastomer. The sealing profile 8 is applied via an adhesion promoter 7. The adhesion promoter 7 contains polyurethanes, chlorinated polyolefins, and an aqueous solvent. The adhesion promoter ensures the adhesion on the protective coating 5,

FIG. 2 depicts another embodiment of a polymeric pane according to the invention in the region of the pane edge. The polymeric pane I depicted corresponds essentially to the pane depicted in FIG. 1. A black print 9 protected by the protective coating 5 is also arranged on the polymeric main body 1. The extruded sealing profile 8 surrounds the pane edge 4 and is arranged on the first pane surface 2, the second pane surface 3, and the pane edge 4. The extruded sealing profile 8 is affixed on the protective coating 5 via an adhesion promoter 7, The adhesion promoter 7 improves the adhesion of the extruded sealing profile 8 on the protective coating. Since the extruded sealing profile 8 surrounds the pane edge 4, the pane edge 4 is optimally protected against damage before, during, and after installation in a window opening. The distance a between an extruded sealing profile 8 and the pane edge 4 is 0 m, since the extruded sealing profile 8 encompasses the pane edge 4..

Fig, 3 depicts a cross-section through another embodiment of a polymeric pane according to the invention in the region of the pane edge. An opaque material phase 10 is arranged on the first pane surface 2 of the polymeric main body 1. The polymeric main body 1 and the opaque material phase 10 contain polycarbonate. The opaque material phase 10 additionally contains a black pigment as a colorant. The opaque material phase 10 conceals the view of the sealing profile 8 positioned there behind, looking from the direction of the second pane surface 3 toward the polymeric pane I. In addition, the opaque material phase 10 contributes to the strength of the polymeric pane I in the edge region 6. The thickness d of the polymeric main body 1 is 4 mm; the thickness of the opaque material phase 10 is 2 mm. The opaque material phase 10 is arranged in an edge region 6. The edge region 6 is 4 cm wide and runs parallel to the pane edge 4. The polymeric main body 1 with the opaque material phase 10 is produced in a two-component injection molding process. First, the polymeric main body 1 is produced in an injection molding tool; and before the removal of the polymeric main body 1, the opaque material phase 10 is injected onto the polymeric main body 1 in this injection molding tool, The entire first pane surface 2 and the second pane surface 3 are provided with a protective coating 5. The opaque material phase 10 is protected by the protective coating 5. The sealing profile 8 is applied on the protective coating 5 via the adhesion promoter 7. The sealing profile 8 runs parallel to the pane edge 4. The distance a between the sealing profile 8 and the pane edge 4 is 1.5 cm. Part of the sealing profile 8 protrudes beyond pane edge 4.

FIG. 4 depicts a cross-section through another embodiment of a polymeric pane according to the invention in the region of the pane edge. The polymeric pane I corresponds essentially to the pane depicted in FIG. 3. The first pane surface 2 is not completely provided with a protective coating 5. The opaque material phase 10 is free of a protective coating 5. The pane edge 4 and the second pane surface 3 are completely protected by the protective coating 5. The first pane surface 2 is intended for the motor vehicle interior side after installation in a motor vehicle opening. The chemical and mechanical stresses are consequently lower than on the second pane surface 3 provided for the outer side. A possible visual damage of the opaque material phase 10 by, for example, scratching, is not so disadvantageous as scratching of a transparent through-vision region. Consequently, protective coating can be saved, in particular with an opaque material phase 10 arranged over a large area. The adhesion promoter 7 is arranged directly on the opaque material phase 10. The adhesion promoter 7 ensures good adhesion of the extruded sealing profile 8 on the opaque material phase 10.

FIG. 5 depicts a top view of the second pane surface 3 of a polymeric pane according to the invention I. The polymeric pane I is implemented rectangular, and a sealing profile 8 is arranged along 3 sides of the polymeric pane I. The sealing profile 8 is implemented as depicted in FIG. 1. It protrudes beyond the pane edge 4. When the second pane surface 3 is viewed from above, only the part of the sealing profile 8 protruding beyond the pane edge 4 is visible. The polymeric main body 1 is implemented transparent and provided with a protective coating 5. In the peripheral edge region 6 of the pane, a black print 9, which is also protected by the protective coating 5, is applied. The black print 9 conceals the view of the part of the extruded sealing profile 8 applied on the first pane surface 2.

FIG. 6 depicts a top view of the first pane surface 2 of a polymeric pane according to the invention I. This is the polymeric pane I depicted in FIG. 5, which is depicted here from the opposite side. When the first pane surface 2 is viewed, the part of the sealing profile 8 protruding beyond the pane edge 4 and the part of the sealing profile 8 applied on the first pane surface 2 are visible. The entire first pane surface is provided with a protective coating.

FIG. 7 depicts a top view of the first pane surface 2 of a polymeric pane according to the invention. The polymeric pane I is intended as a roof panel for a motor vehicle. The polymeric main body 1 is implemented transparent. The polymeric main body 1 is produced in the two-component injection molding process together with the opaque material phase 10. The opaque material phase 10 extends over more than 50% of the surface of the polymeric main body 1. The opaque material phase 10 hides, for one thing, the sealing profile 8 and other objects and thus improves the visual appearance of the polymeric pane I when looking at the second pane surface 2. For another, the opaque material phase 10 improves the stability of the polymeric pane I. The through-vision region of the roof panel is situated in the region in which no opaque material phase 10 is arranged. In this region, a protective coating 5, with which the part of the polymeric pane I facing the vehicle interior is protected against scratching, is arranged on the first pane surface 2. In this embodiment, the opaque material phase 10 is not provided with a protective coating 5 since, after installation of the vehicle headliner, this region is covered and thus no protection against scratching is required. The entire second pane surface 3, which is not depicted in FIG. 7, is provided with the protective coating 5, since the motor vehicle exterior is exposed to high mechanical stresses, The sealing profile 8 is applied, as depicted in FIG. 4, directly on the opaque material phase 10 via an adhesion promoter 7. In this case, the sealing profile 8 is arranged peripherally along the entire pane edge 4 and and serves for fixing and sealing the pane in the roof window opening.

FIG. 8 depicts a flowchart of a method according to the invention. First, a polymeric main body 1 is provided by, for example, an injection molding process. Optionally, the polymeric main body 1 can, for example, be provided with a black print 9 by a screen printing method. Then, a protective coating 5 is applied, for example, by a flow coating method, preferably on the first pane surface 2 and the second pane surface 3. Then, optionally, the parts of the second pane surface 3 onto which the extruded sealing profile 8 is to be applied are activated. Preferably, this is done using atmospheric plasma. The adhesion promoter 7, onto which the sealing profile 8 is then extruded directly, can be applied on the activated region. By means of the direct extrusion, a particularly stable bond is produced between the sealing profile 8 and the coated second pane surface 3.

### LIST OF REFERENCE CHARACTERS

I polymeric pane

1 polymeric main body

2 first pane surface

3 second pane surface

4 pane edge

5 protective coating

6 edge region of the pane

7 adhesion promoter

8 extruded sealing profile

9 black print

10 opaque material phase

a distance between the sealing profile and the pane edge

d thickness of the polymeric main body

1.-13. (canceled)

14. A polymeric pane, comprising:
a polymeric main body, having a first pane surface, a second pane surface, and a peripheral pane edge;
a protective coating on the entire second pane surface and on at least a part of the first pane surface; and
an extruded-on sealing profile arranged on a side of the first pane surface via an adhesion promoter.

15. The polymeric pane according to claim 14, wherein the sealing profile is arranged parallel to the pane edge and a distance ‘a’ from the sealing profile to the pane edge is less than 5 cm.

16. The polymeric pane according to claim 15, wherein the distance ‘a’ is less than 2 cm.

17. The polymeric pane according to claim 16, wherein the distance ‘a’ is less than 0.5 cm.

18. The polymeric pane according to claim 15, wherein the adhesion promoter and the extruded sealing profile are arranged peripherally along the entire pane edge.

19. The polymeric pane according to claim 15, wherein the adhesion promoter and the extruded sealing profile are arranged only along a part of the pane edge.

20. The polymeric pane according claim 14, wherein the extruded sealing profile protrudes beyond the pane edge.

21. The polymeric pane according claim 14, wherein the extruded sealing profile is arranged on the first pane surface and on the second pane surface, encompassing the pane edge.

22. The polymeric pane according to claim 14, wherein a black print is arranged on the first pane surface at least on one edge region of the pane.

23. The polymeric pane according to claim 14, wherein an opaque material phase is arranged on the first pane surface at least on the edge region of the pane.

24. The polymeric pane according to claim 14, wherein the extruded sealing profile contains thermoplastic elastomers, thermoplastic polyurethanes, styrene copolymers, polyolefin rubber blends, polyolefin elastomer blends, thermoplastic copolyamides, thermoplastic copolyesters, and/or mixtures thereof.

25. The polymeric pane according to claim 14, wherein the adhesion promoter contains polyurethanes, epoxy resins, chlorinated polyolefins, and/or mixtures thereof.

26. A method for producing the polymeric pane according to claim 14, comprising:
providing the polymeric main body;
applying the protective coating on the second pane surface;
applying the adhesion promoter on the first pane surface in the region provided for the sealing profile; and
extruding the sealing profile on the adhesion promoter.

27. The method according to claim 26, further comprising:
activating the first pane surface in the region provided for the sealing profile;
wherein the activating the first pane surface is performed prior to the applying of the adhesion promoter.

28. The method according to claim 27, wherein the activating is done by using atmospheric plasma.

29. The method according to claim 26, further comprising:
using the polymeric pane as a pane, or as a component of a pane, as means of transportation for travel on land, in the air, or on water, as a rear window, or windshield, or side window, or roof panel, or luminaire covering, or molding, or as a vehicle roof of passenger cars, trucks, buses, streetcars, subways, trains, and motorcycles.
